(19) United States
(12) Patent Application Publication
(10) Pub. No.: US 2010/0036598 A1
(43) Pub. Date: Feb. 11, 2010

(54) Information Processing System and Method for Processing Information Regarding Consecutive Units

(76) Inventor: Guido Mueller, Quedlingberg (DE)

Correspondence Address: KENYON & KENYON LLP, ONE BROADWAY, NEW YORK, NY, 10004, US

(21) Appl. No.: 12/083,858

(22) PCT Filed: Oct. 11, 2006
(86) PCT No.: PCT/EP2006/067298

§ 371 Date: Oct. 14, 2009

(30) Foreign Application Priority Data
Oct. 18, 2005 (DE) 10 2005 049 769.1

(51) Int. Cl. G01C 21/36; G06F 17/30

(52) U.S. Cl. 701/200; 707/5; 707/E17.017

(57) ABSTRACT

For the further development of an information processing system (navigation assistance), an allocated navigation system, and a method for processing data with regard to successive units, such as successive spatial and/or temporal route segments of a path, at least one information list having at least one information element being allocated to each unit, in such a way that data or information items that are equivalent per se, such as road names or road numbers of a path or a route, are weighted with regard to successive units, such as path segments or route segments, and especially so that no faulty data (travel recommendations) are output that irritate and/or disturb the user, it is provided that in at least one of the information lists at least one of the information elements is weighted while taking into consideration the relationship, as a function of the order, of the unit, to which this information list is allocated, to at least one of the further units.

However, the sequence within a road category is random or the road numbers are used by increasing numerical value.

This problem will be illustrated below by giving a few examples of the output of travel recommendations with respect to road numbers. The routes with regard to the general road situation shown in FIG. 2 are used as examples.

The current illustration of the travel recommendations in conventional navigation units, such as model “DX-N” of the firm Blaupunkt or in similar navigation units is illustrated in FIG. 3.

The first route runs
to first decision point E1, particularly to the first location or junction along federal road B65,
to second decision point E2, particularly to the second location or to the second junction along federal road B6 as well as federal road B65,
to third decision point E3, particularly to the third location or the third junction along federal road B3, federal road B6 as well as federal road 65.
to the destination along federal road B65.

Without special sorting, the following is displayed in conventional navigation units:

| | |
|---|---|
| +B65 | --> E1 |
| +B6/B65 | --> E2 |
| +B3/B6/B65 | --> E3 |
| +B65 | |

Depending on the state of the software and data carriers used, the bordering streets are shown in addition for the crossings and junctions:

| | |
|---|---|
| +B65 | --> E1 [B6] [B65] |
| +B6/B65 | --> E2 [B3] [B6] [B65] |
| +B3/B6/B65 | --> E3 [B3] [B6] [B65] |
| +B65 | |

With the aid of this first exemplary route 12 it becomes clear that, although entire first route 12 runs continuously over federal road B65, the important or primary road numbers are perpetually changing in the route list. This circumstance tends to be a real problem when the important or primary number is given out verbally besides, or instead of a visual display:

| Route List | | Travel Recommendations |
|---|---|---|
| +B65 | --> E1 | “turn right and follow B6” |
| +B6/B65 | --> E2 | “turn left and follow B3” |
| +B3/B6/B65 | --> E3 | “straight ahead and follow B65” |
| +B65 | | |

Because of the perpetual change of the road number that is suggested by the travel recommendations, the driver is bothered with information that is of little help, and is diverted unnecessarily by road traffic, which is undesired.

The second route (reference numeral 14), described below with the aid of FIG. 4, characterizes a seemingly very similar problematic case which is meaningful because of the different form of its result.

Second route 14 runs
to first decision point E1, particularly to the first location or to the first junction along federal road B65,
to second decision point E2, particularly to the second location or to the second junction along federal road B6 as well as federal road B65,
to third decision point E3, particularly to the third location or the third junction along federal road B3, federal road B6 as well as federal road 65, and
to the destination along federal road B3.

The navigation systems named at the outset, such as model “DX-N” of the firm Blaupunkt and similar navigation systems, show the route list as follows, and accordingly they output the following travel recommendations:

| Route List | | Travel Recommendations |
|---|---|---|
| +B65 | --> E1 | “turn right and follow B6” |
| +B6/B65 | --> E2 | “turn left and follow B3” |
| +B3/B6/B65 | --> E3 | “turn right and follow B3” |
| +B3 | | |

By contrast to first route 12 (cf. FIG. 3), in the case of second route 14 (cf. FIG. 4) an actually necessary change in the road numbers takes place, but the user is notified of two changes in the road number. Second exemplary route 14 is described especially to show genuine change in the road number, since these changes in the road numbers can be submitted to a typical form of the present invention.

### SUMMARY

Starting from disadvantages and shortcomings shown above, and while acknowledging the outlined related art, example embodiments of the present invention provide an information processing system, especially a navigation assistance of the type named at the outset, a navigation system allocated to this information processing system as well as a method of the type named at the outset. This is to be done in such a way that equivalent data or information per se, such as road names or road numbers of a path or a route, are weighted with respect to successive units, such as with respect to successive segments of the path or road, in particular, in such a way that no information, especially travel recommendation, is output that is erroneous, irritates and/or disturbs the user.

According to example embodiments of the present invention, the description of successive units, for instance, the description of a path composed of various route segments, takes place by information with respect to these units, especially by information with respect to the individual route segments.

At least one information list having at least one information element is assigned to each unit, in this context. The information lists assigned to the units advantageously in each case regard at least one information category or information type. For example, the at least one information element of the respective information list is able to have at least one road name and/or at least one road number, and is able to be allocated to the information category “highway”.

It is also possible for different information lists to be assigned to each of these units, particularly to each of these route segments, which each refer to different information categories.

In the case of the weighting undertaken, according to example embodiments of the present invention, of the one or of the several information elements of the respective information list, in accordance with an example embodiment of the present invention, this information element is assigned to at least one of at least two priority categories, such as of the category primary information element or the category alternative information element.

Furthermore, the one information element or the several information elements in the respective information list are able to be sorted corresponding to its or their weighting, the order or sequence of the information elements in the respective information list reflecting the importance or the significance of the respective information element. According to an example embodiment of the present invention, the first element thus has the greatest importance and is designated as the primary element.

An example embodiment of the information system of the present invention is designed to output at least one part of the weighted data, such as the data assigned to the category primary information element, for instance, as at least one travel recommendation. This output of the information may be output optically and/or acoustically.

Since various information categories or various information types do not have to have any direct relationship to one another, according to an example embodiment of the present invention, in the case of the weighting of the at least one information element of the respective information list, only information lists concerning the same information category or the same information type of the other units are considered.

For better illustration, from now on the described advantageous forms of the present invention will relate only to one information category or one information type in one weighting pass.

If information elements of a plurality of information categories or of a plurality of information types are to be weighted, the weighting will advantageously be run through successively for each information category.

In this context, the weighting of the respective information elements of information lists of different information categories or different information types may be determined in a different manner; for instance, for each information category a different form of the present invention, particularly a different form of the method may be used.

Thus, according to an example embodiment of the present invention, the weighting of the respective information element, particularly the specification for the at least one primary element of the respective information list, is able to be determined by the weighting of the corresponding information element in at least one of the further units, especially in the preceding and/or following spatial and/or temporal segment, for instance, in the preceding and/or following route segment of the path.

If the specification for the at least one primary element of the respective information list is determined, for example, by the primary element of the spatially and/or temporally preceding unit, a change in the information determined as the primary element takes place as late as possible.

In the case of weighting according to the exemplary embodiment described above, in the case of an example embodiment of the present invention, in particular in the case of an example embodiment of the navigation system according to an example embodiment of the present invention, in which at least a part of the weighted data, such as the data assigned to the category primary information element, is output using a loudspeaker and/or a monitor as at least one of the travel recommendations, in the case of a route change, this route change is output as late as possible.

By contrast, if the specification for the at least one primary element of the respective information list is determined, by the primary element of the spatially and/or temporally following unit, a change in the information determined as the primary element takes place as early as possible.

Independently of, or in connection with the possibilities of weighting the respective information elements described above, it is also possible for the weighting of the respective information elements, particularly the specification of the at least one primary element of the respective information list, to be determined by the probability that at least two of the information elements assigned to the respective units are connected to each other, particularly that they are contiguous.

A change in the information determined as the primary element takes place, according to this exemplary embodiment, independently of the direction of the route, but always at the same place.

According to an example embodiment of the present invention, for the weighting of the at least one information element, particularly for the determination of the primary information element, there exist the above three advantageous forms, particularly method forms, having their significant properties.

Example embodiments of the present invention offer the advantage that the disadvantages shown in the section “Background Information” in light of the two route examples can be removed in the continuity of the information mapping.

In this context, expediently the weighting of the primary element essentially comes into focus. According to an example embodiment of the present invention, the sorting of the other information element alternatives is of subordinate importance.

Furthermore, example embodiments of the present invention offer the advantage that
segment-related multiple data corresponding to a path, such as road names or road numbers are able to be presented in optimized fashion in the route list of navigation systems;
great continuity in the segment-related information presentation is made possible, and frequent changes are avoided; and
required changes in the segment-related information presentation take place optimized with respect to the path.

Example embodiments of the present invention are not tied to a specific information type, in this context; the method provided herein cannot only be used to optimize the indication of road names or numbers in route lists of navigation systems, but is also usable for optimizing the representation of similar problem cases.

Moreover, example embodiments of the present information are not restricted to one certain number of alternative data.

An example embodiment of the navigation system according to the present invention makes possible for a user an optimized representation of alternative names and numbers, by having a priority specification oriented to the routing or by having a sorting of alternative road names and numbers oriented to the routing.

This signals a great continuity in the roads used, depending on the situation. This becomes clear especially in utilizing the primary information element, for instance, the primary road number, for the acoustical presentation of the at least one travel recommendation.

In addition, according to an example embodiment of the present invention, the continuity of the primary element, for instance, the road name or number, is maintained for as long as possible, in order not to provoke any irritation in response to the at least one travel recommendation, especially in response to acoustical travel recommendations.

According to an example embodiment of the present invention, especially of the navigation system of an example embodiment of the present invention, the representation of multiple data that are equivalent per se and are segment-related or unit-related, takes place in such a way that the sequence of the data for one unit or one segment is sorted in such a way that
the priority of the information in the information list decreases for a unit or for a segment,
a change in the sequence of the data is minimized, and
a change in the important information elements takes place in a manner optimized with respect to path, depending on the form, especially the method form.

Furthermore, example embodiments of the present invention concern a computer program product having at least one program section for executing a method according to the type explained above.

In addition, example embodiments of the present invention relate to a machine-readable data memory or data carrier, particularly a computer-readable storage module, for instance, a C[ompact]D[isk], a D[igital]V[ersatile]D[isc] or a memory stick
on which at least one computer program product is recorded and/or stored according to the manner shown above, and
that is provided for making current and/or updating at least one information processing system, particularly at least one navigation assistance, according to the type explained at the outset.

Example embodiments of the present invention may be used generally for optimizing the presentation of data relating to successive units or to segments, and especially for the path-optimized representation of segment-related multiple data.

Finally, example embodiments of the present invention relate to the use
of at least one information processing system, in particular, at least one navigation assistance according to the type shown above, and/or
of a method according to the type shown above and/or
of at least one computer program product according to the type shown above and/or
of at least one machine-readable data memory or data carrier, particularly at least one computer-readable storage module, for example, at least one C[ompact]D[isk], at least one D[igital]V[ersatile]D[isc] or at least one memory stick according to the type shown above
   in at least one navigation system according to the type shown above, for instance, in a navigation system “RNS-MFD2” of the firm Blaupunkt, that has a map system.

As already explained above, there are various possibilities for advantageously implementing and refining example embodiments of the present invention. For this purpose, further example embodiments, features, and advantages of example embodiments of the present invention are described in greater detail in the following on the basis of the three exemplary embodiments illustrated by FIGS. 1 through 11.

### BRIEF DESCRIPTION OF THE DRAWINGS

FIG. 1 a schematic representation of an exemplary embodiment for a navigation system according to the present invention, having an information processing system according to an example embodiment of the present invention and operating according to the method of an example embodiment of the present invention;

FIG. 2 a schematic representation of an example of a traffic or road situation, shown as a road map section, in which the navigation system in FIG. 1, and, in this connection, particularly the information processing system in FIG. 1 is able to be used;

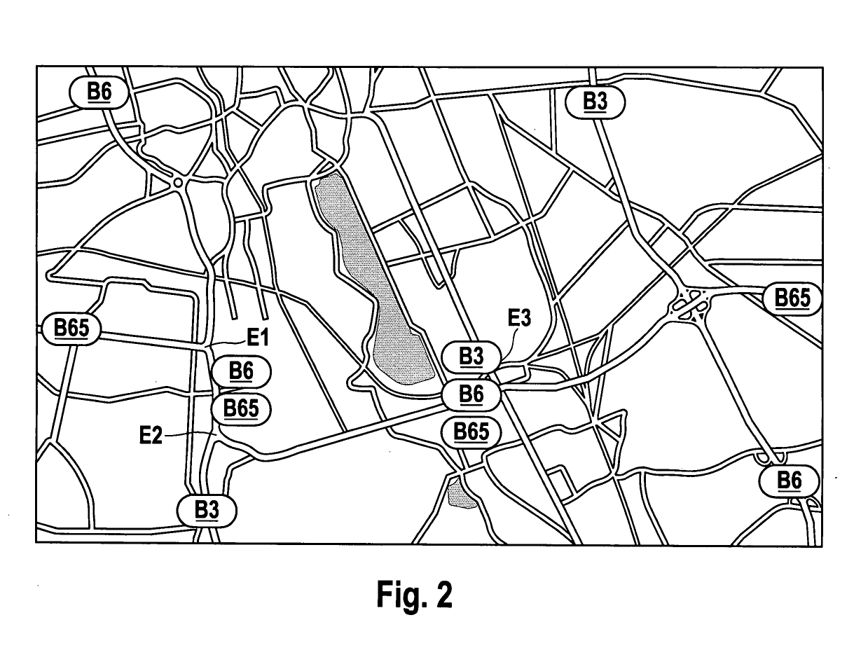

FIG. 3 a schematic representation of a first example for a routing visually high-lighted by enhancement, in the traffic situation or road situation shown in FIG. 2;

FIG. 4 a schematic representation of a second example for a routing visually high-lighted by enhancement, in the traffic situation or road situation shown in FIG. 2;

FIG. 5 a schematic representation of an example of data with respect to successive units that are stored in the navigation system of FIG. 1;

FIG. 6 a schematic representation of a sequence/flow diagram of a first exemplary embodiment for a method according to the present invention;

FIG. 7 a schematic representation of a sequence/flow diagram of a second exemplary embodiment for a method according to the present invention;

FIG. 8 a schematic representation of a sequence/flow diagram for a detailed view of a step of the method in FIG. 6 and FIG. 7, namely, the step of weighting or sorting the information elements of one of the units;

FIG. 9 a schematic representation of a sequence/flow diagram of a third exemplary embodiment for a method according to the present invention;

FIG. 10 a schematic representation of a sequence/flow diagram for a detailed view of a step of the method in FIG. 9, namely, the step of determining the probability that at least two of the information elements assigned to the respective units are connected to each other; and

FIG. 11 a schematic representation of a sequence/flow diagram for a detailed view of a step of the method in FIG. 9, namely, the step of weighting or sorting the information elements of one of the units.

### DETAILED DESCRIPTION

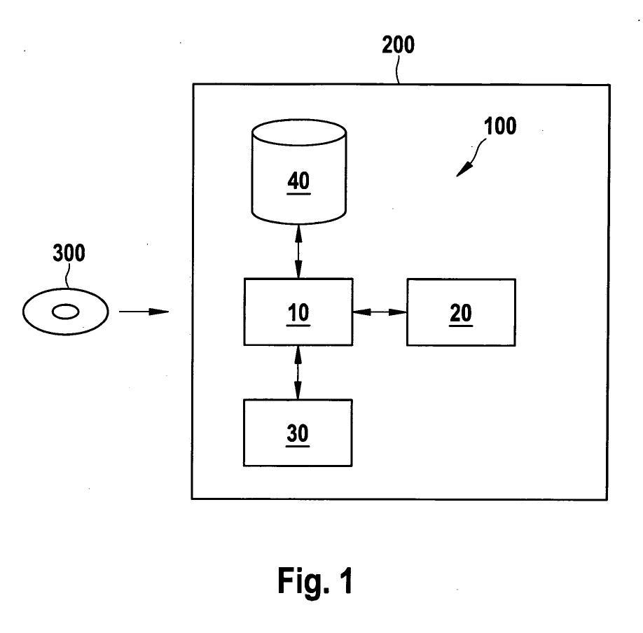

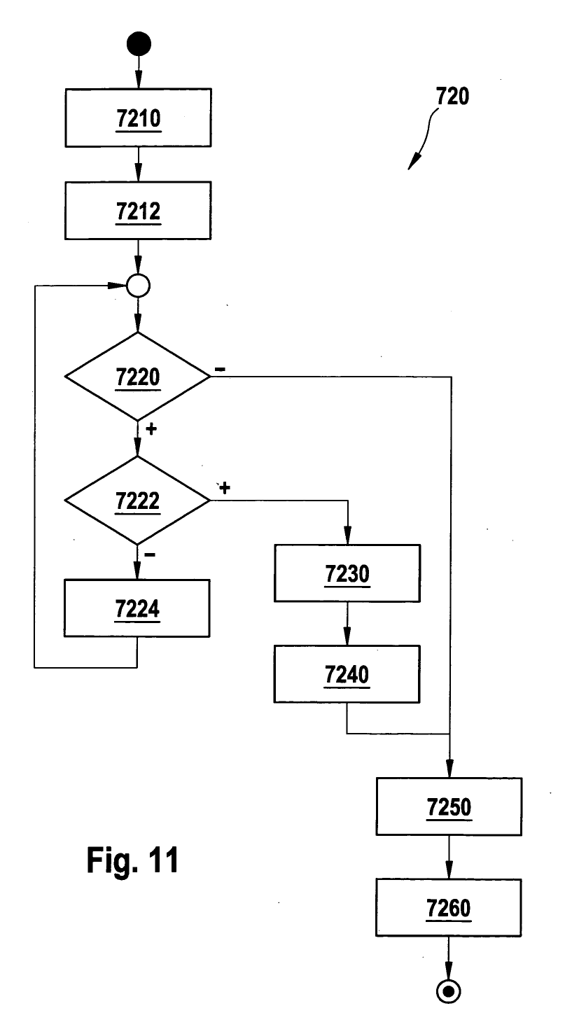

In FIGS. 1 and 11, equal or similar embodiments, elements or features are provided with identical or equivalent reference numerals.

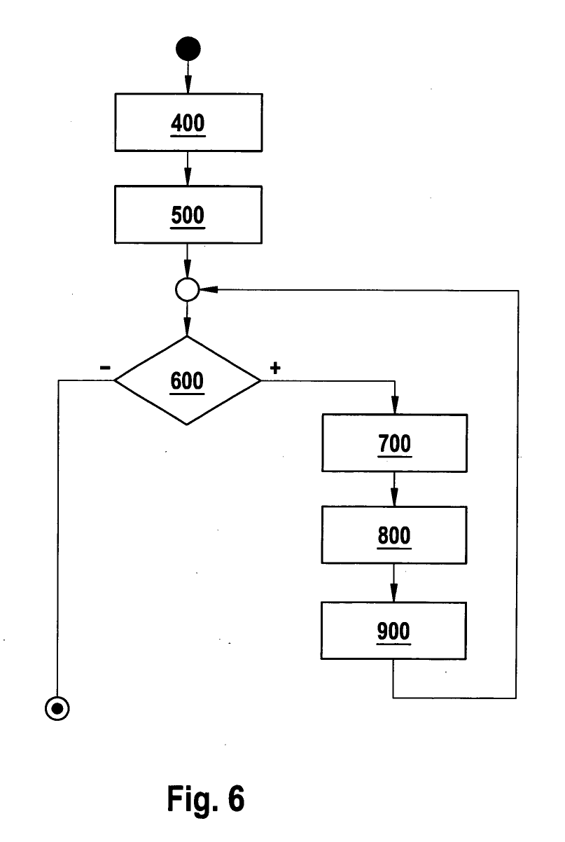

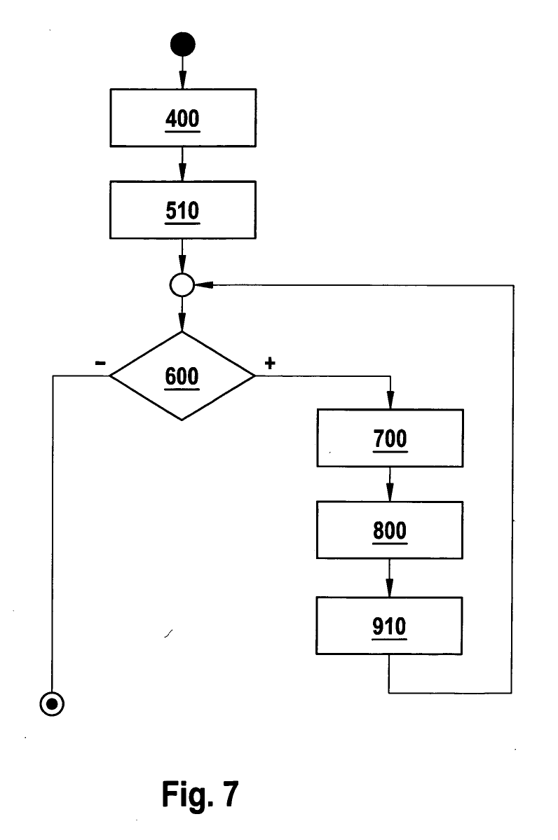

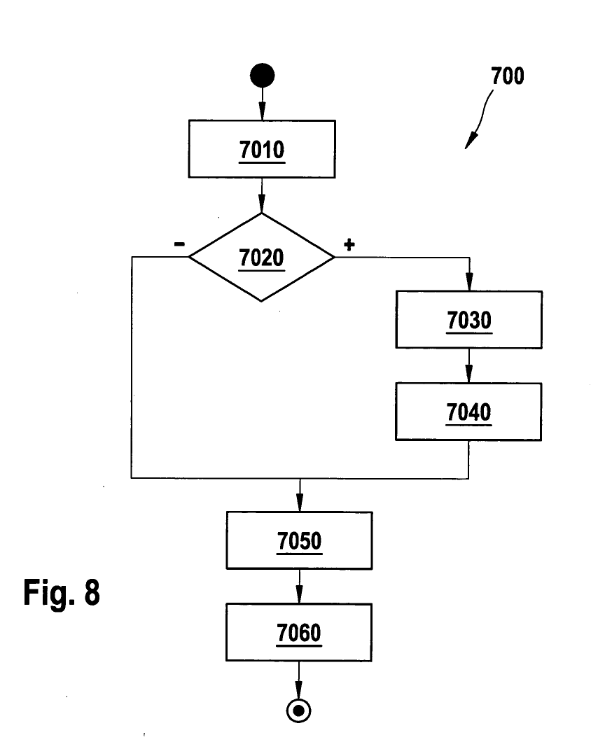

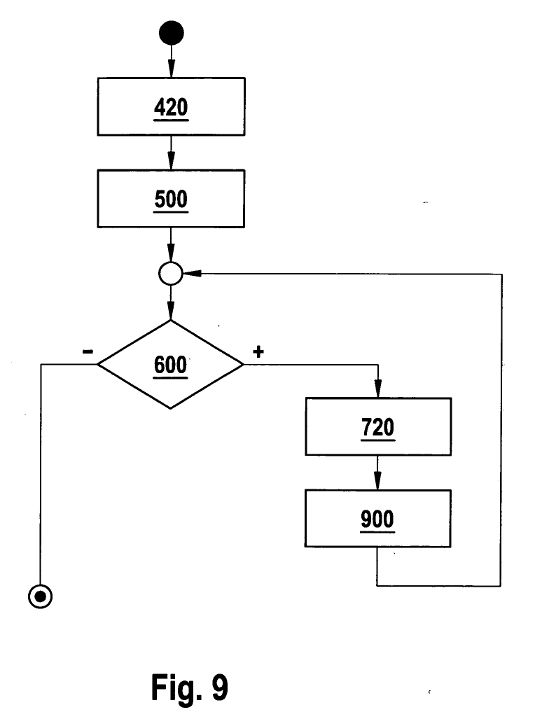

In order to avoid superfluous repetitions, the following explanations, with respect to the example embodiments, the features and the advantages of example embodiments of the present invention (unless it is noted differently) refer
to the first exemplary embodiment of the method according to the present invention shown in FIGS. 6 and 8
and to the second exemplary embodiment of the method according to the present invention shown in FIGS. 7 and 8
and to the third exemplary embodiment of the method according to the present invention shown in FIGS. 9 and 11.

FIG. 1 shows a navigation system 200 according to an example embodiment of the present invention, having a information processing system 100, in particular having a navigation assistance according to an example embodiment of the present invention.

Navigation assistance 100, and, with that, also navigation system 200 are able to be made current or updated using a computer-readable data memory 300 in the form of a C[ompact]D[isc], on which a corresponding computer program is recorded and stored. In place of the C[ompact]D[isc], any other suitable data carrier may be used, such as a D[igital]V[ersatile]D[isc] or any other suitable semiconductor storage module, such as a memory stick. Alternatively, or in supplementation of this, the updating may also be performed online, such as by remote data transmission or by the Internet.

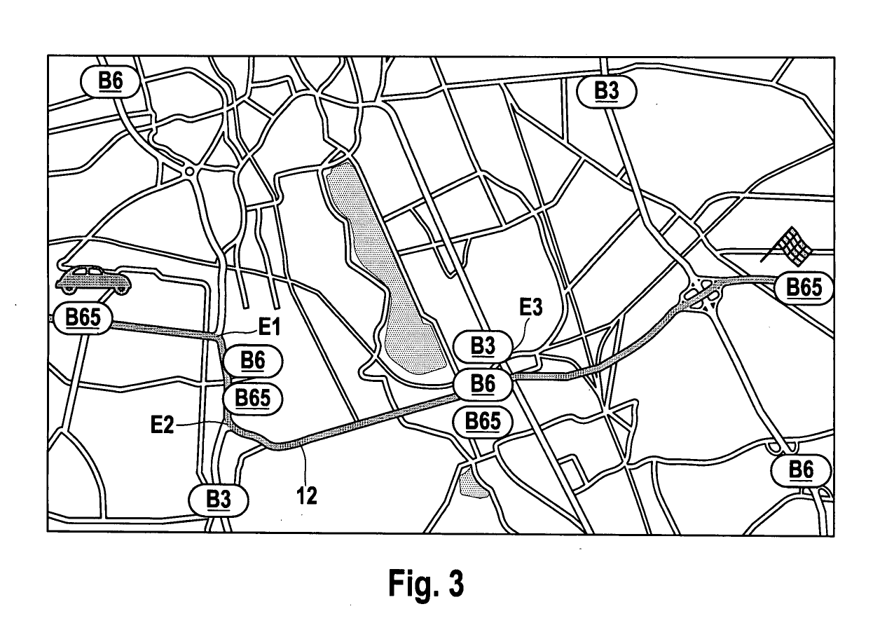

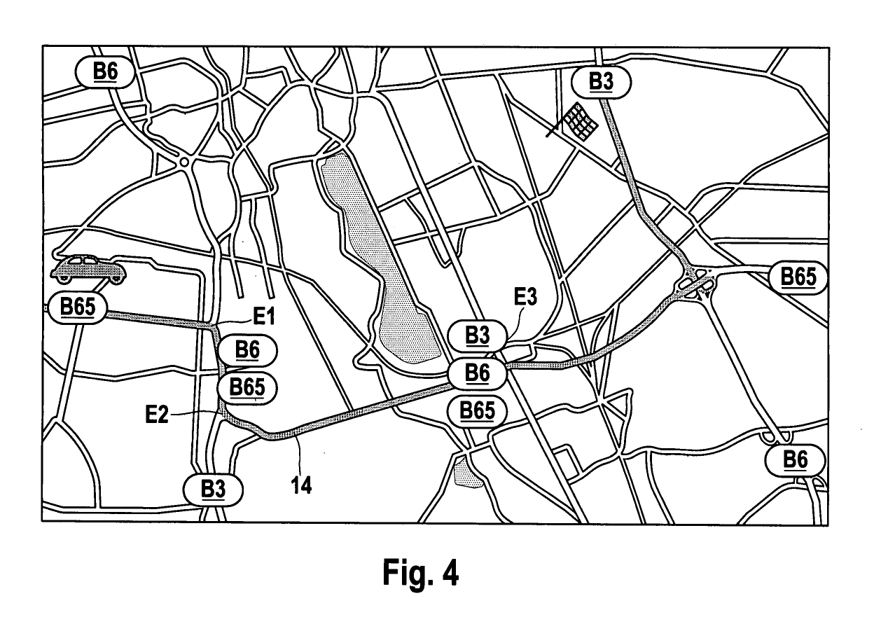

Navigation assistance 100 has a position-finding/processing unit 10 for ascertaining possible routes 12 (cf. FIG. 3) or 14 (cf. FIG. 4) from a point of departure to a destination. Position-finding/processing unit 10 communicates with a (or a plurality of) route guidance unit(s) 20 for the output of travel recommendations, which guide the driver of the means of conveyance along the specified route 12, 14.

Furthermore, position-finding/processing unit 10 communicates with one or more sensors 30, by which the current position of the means of conveyance is continuously recorded.

Moreover, navigation assistance 100 has at least one memory unit 40, particularly at least one databank, to store data with respect to successive units 52, 54, 56, 58, and particularly with regard to successive spatial and/or temporal segments, for instance, with regard to route segments of path or route 12, 14.

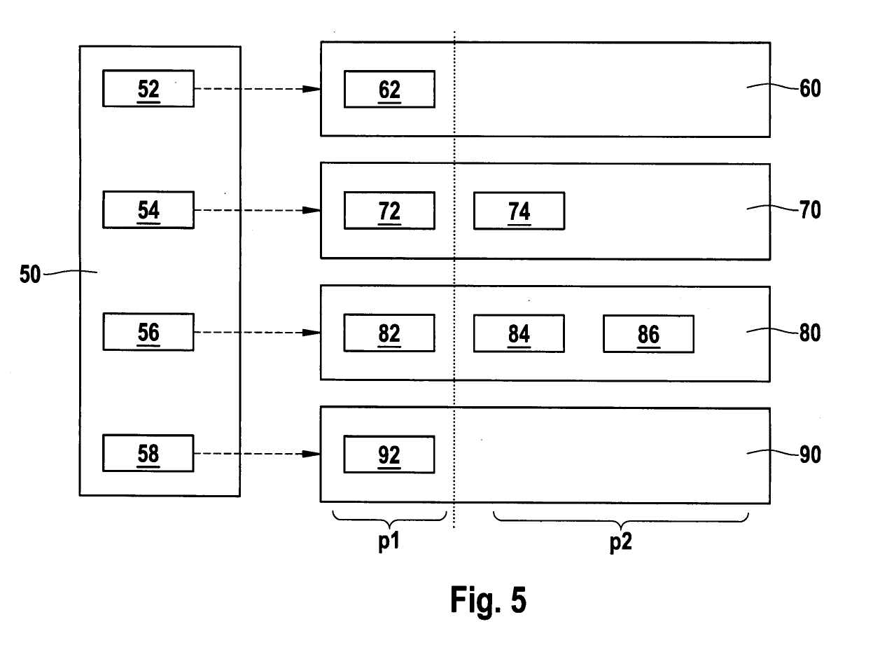

As is shown in FIG. 5, the description of routes 12 or 14 takes place by the sum 50 of successive units 52, 54, 56, 58; these units 52, 54, 56, 58 may be stored particularly in at least one table and/or in at least one route list or unit list.

To each of these units 52, 54, 56, 58 various information types or various information categories may be assigned. If a plurality of data are admissible for certain data types or data categories, these are described by an information table or information list 60, 70, 80, 90.

In the example shown in FIG. 5, units 52, 54, 56, 58 describe the route segments of path or route 12, 14,
segment 52 corresponding to the route extension from the starting point to first decision point E1, particularly to the first location or the first junction,
segment 54 corresponding to the route extension from first decision point E1 to second decision point E2, particularly to the second location or the second junction,
segment 56 corresponding to the route extension from second decision point E2 to third decision point E3, particularly to the third location or the third junction, and
segment 58 corresponding to the route extension from third decision point E3 to the destination.

The information lists 60, 70, 80, 90 are assigned to information category “highway”.

Each information list 60, 70, 80, 90 is subdivided into two priority categories, namely the category “primary elements” p1 and the category “alternative elements” p2, and has at least one information element 62, 72, 74, 82, 84, 86, 92.

The respective sequence of information elements 62 and 72, 74 and 82, 84, 86 and 92 in information list 60 and 70 and 80 and 90 reflects their respective importance. In this context, the first information element 62, 72, 82, 92 in each case has the greatest importance respectively, and is designated in each case as the primary element.

In the present case, each information element 62 and 72, 74 and 82, 84, 86 and 92 describes a road name or a road number of a segment 52 or 54 or 56 or 58 of route 12, 14.

The respective weighting or sorting of information elements 62 and 72, 74 and 82, 84, 86 and 92 may be carried out in a different manner.

A decisive feature of the first exemplary embodiment of the method of an example embodiment of the present invention shown in FIG. 6 is that, in the case of a change in the road number or the road name, the primary information element changes as late as possible, and thus the new road number or the new road name is output as late as possible as the travel recommendation.

This means that a primary information element, such as a road number determined to be a primary information element or a road name determined to be a primary information element remain constant as long as possible. In this context, the primary information element is determined by the previous segment 52, 54, 56, 58 in the path or route 12, 14.

The method sequence for processing segments 52, 54, 56, 58 of route 12, 14 in an information category, namely the information category “highway”, according to the first exemplary embodiment of the method according to the present invention is described by FIG. 6.

Before the actual processing of segments 52, 54, 56, 58 of path 12, 14, the preferred primary information element is initialized (reference numeral 400), that is, the preferred primary information element is empty. In the following loop, all segments 52, 54, 56, 58 of path 12, 14 are processed, beginning with first segment 52.

Sorting based on the preferred primary information element takes place first, in this instance, and then primary element 62 of current segment 52 is transferred as the new preferred primary information element 62 for following segments 54, 56, 58.

After step 400 of initializing the preferred primary information element, current segment 52 or 54 or 56 or 58 is equated to first segment 52 of path 12, 14 (reference numeral 500).

Then it is tested (reference numeral 600) whether a current segment 52 or 54 or 56 or 58 is present. If no current segment 52 or 54 or 56 or 58 is present (reference symbol “−”), the method is ended.

If, however, there exists a current segment 52 or 54 or 56 or 58 (reference symbol “+”), a weighting (reference numeral 700), namely a sorting of data 62 or 72, 74 or 82, 84, 86 or 92 of current segment 52 or 54 or 56 or 58 is carried out based on preferred primary information elements 62 or 72 or 82 or 92.

The actual sorting 700 of data 62 or 72, 74 or 82, 84, 86 or 92 of a segment 52 or 54 or 56 or 58 based on specified preferred primary information element 62 or 72 or 82 or 92 is shown in FIG. 8.

At the beginning, at least one result list is initialized or deleted (reference numeral 7010). Then preferred primary information element 62 or 72 or 82 or 92 is searched for in information list 60 or 70 or 80 or 90 of given segment 52 or 54 or 56 or 58 (reference numeral 7020).

If preferred primary information element 62 or 72 or 82 or 92 is present or included in it, it is removed from information list 60 or 70 or 80 or 90 of segment 52 or 54 or 56 or 58 and is transferred into previously initialized or deleted (cf. step 7010) result list (reference numeral 7030).

Thereafter, the remaining information elements 74 or 84, 86 of segment 54 or 56 are transferred to the result list before this result list can be allocated to respective segment 52, 54, 56, 58 as information list 60, 70, 80, 90.

Corresponding to the example of first route 12 (cf. FIG. 3), in which entire route 12 runs on federal road B65, and only touches on federal road B6 and federal road B3 in a shared manner, the first exemplary embodiment of the method, described above, of the present invention makes possible an optimized route list as well as optimized travel recommendations.

As a result of the sorting according to FIGS. 6 and 8, the following route list relating to first route 12 (cf. FIG. 3) and travel recommendations are output having an optimized road number sequence.

| Route List | | Travel Recommendations |
|---|---|---|
| +B65 | --> E1 | “turn right and keep following B65“ |
| +B65/B6 | --> E2 | “turn left and keep following B65” |
| +B65/B3/B6 | --> E3 | “straight ahead and continue following B65” |
| +B65 | | |

Furthermore, the continuity in the road name and the road number is maintained as long as possible for the user, so as not to provoke any irritation in response to travel recommendations, especially when they are output in acoustical form.

The change in the road name and the road number takes place as late as possible in the method shown in FIGS. 6 and 8. This feature of sorting road names and numbers becomes clear when it comes to second route 14 (cf. FIG. 4).

As a result of the sorting according to FIGS. 6 and 8, the following route list relating to second route 14 (cf. FIG. 4) and travel recommendations are output having an optimized road number sequence:

| Route List | | Travel Recommendations |
|---|---|---|
| +B65 | --> E1 | “turn right and keep following B65” |
| +B65/B6 | --> E2 | “turn left and keep following B65” |
| +B65/B3/B6 | --> E3 | “straight ahead and continue following B3” |
| +B3 | | |

A decisive feature of the second exemplary embodiment of the method of the present invention shown in FIG. 7 is that, in the case of a change in the road number or the road name, the primary information element changes as early as possible, and thus the new road number or the new road name is output as early as possible as the travel recommendation.

In the second exemplary embodiment, the primary information element is determined by the succeeding segment 52, 54, 56, 58 in path or route 12, 14.

The method sequence for processing segments 52, 54, 56, 58 of route 12, 14 in an information category, namely the information category “highway”, according to the second exemplary embodiment of the method according to the present invention is described by FIG. 7.

Before the actual processing of segments 52, 54, 56, 58 of path 12, 14, the preferred primary information element is initialized (reference numeral 400), that is, the preferred primary information element is empty.

In the following loop, all segments 52, 54, 56, 58 of path 12, 14 are processed, beginning with last segment 58, the sorting based on the preferred primary information element taking place first, and then primary element 92 of current segment 58 is transferred as the new preferred primary information element for following segments 56, 54, 52 to be processed.

The actual sorting of the data of a segment 56 based on the specified preferred primary element 92 is shown in FIG. 8, and it corresponds to the sorting of the data of a segment 52 or 54 or 56 or 58 according to the first specific embodiment.

Corresponding to the example of first route 12 (cf. FIG. 3), in which entire route 12 runs on federal road B65, and only touches on federal road B6 and federal road B3 in a shared manner, the second exemplary embodiment of the method of the present invention makes possible an optimized route list as well as optimized travel recommendations, there being no difference from the other forms, especially from the other method forms.

As a result of the sorting according to FIGS. 7 and 8, the following route list relating to first route 12 (cf. FIG. 3) and travel recommendations are output having an optimized road number sequence:

| Route List | | Travel Recommendations |
|---|---|---|
| +B65 | --> E1 | “turn right and keep following B65” |
| +B65/B6 | --> E2 | “turn left and keep following B65” |
| +B65/B3/B6 | --> E3 | “straight ahead and continue following B65” |
| +B65 | | |

By contrast to first exemplary route 12, a significant difference comes about between the first example embodiment of the method according to the present invention (cf. FIG. 6) and the second example embodiment of the method according to the present invention (cf. FIG. 7) for second route 14 (cf. FIG. 4), since the change in the road number in the second example embodiment of the method according to the present invention takes place as early as possible.

As a result of the sorting according to FIGS. 7 and 8, the following route list relating to second route 14 (cf. FIG. 3) and travel recommendations are output having an optimized road number sequence:

| Route List | | Travel Recommendations |
|---|---|---|
| +B65 | --> E1 | “turn right and keep following B65” |
| +B65/B6 | --> E2 | “turn left and follow B3” |
| +B3/B6/B65 | --> E3 | “straight ahead and continue following B3” |
| +B3 | | |

In the third exemplary embodiment of the method according to the present invention shown in FIGS. 9 to 11, the utilization distribution of an information element 62 or 72, 74 or 82, 84, 86 or 92 for contiguous segments determines primary element 62 or 72 or 82 or 92 of a segment 52 or 54 or 56 or 58.

Since the distribution is determined only by specific properties, such as length or travel time for the current segment, and not by the sequence, the place of change of primary information elements 62 or 72 or 82 or 92 remains the same for each route 12, 14, independent of the direction.

The method sequence for processing segments 52, 54, 56, 58 of route 12, 14 in an information category, namely the information category “highway”, according to the third exemplary embodiment of the method according to the present invention is described by FIG. 9.

First of all, the utilization distribution of information elements 62 or 72, 74 or 82, 84, 86 or 92 is determined or ascertained with respect to the contiguous segments of path 12, 14 (reference numeral 420).

Then, in a loop, all segments 52, 54, 56, 58 of path 12, 14 are processed, beginning with first segment 52. In this context, information elements 62 or 72, 74 or 82, 84, 86 or 92 of respective segment 52 or 54 or 56 or 58 are sorted (reference numeral 720) according to the previously determined utilization distribution in the specified sequence.

The utilization distribution is organized in at least one addressable list, the elements being able to be uniquely determined via information element 62 or 72, 74 or 82, 84, 86 or 92 and the respective contiguous segment, described by the first and last appertaining segment in the path.

The respective value of an entry is determined by the accumulated properties of the contiguous segment.

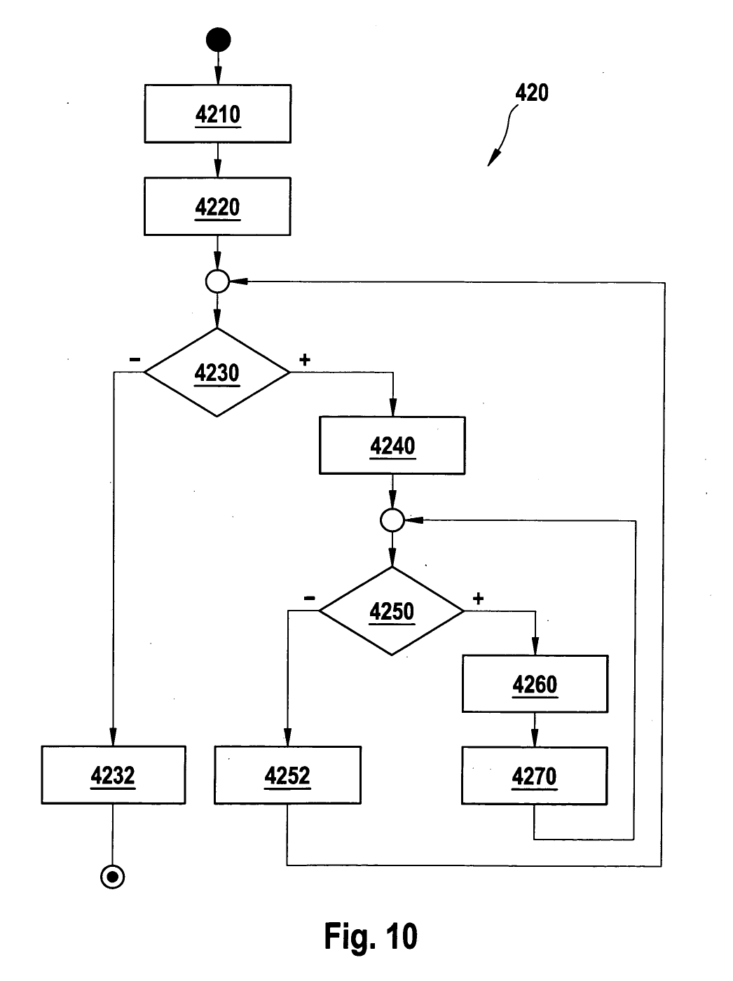

The determination or ascertainment 420 of the utilization distribution of the information elements for contiguous segments is shown in FIG. 10.

The list describing the utilization distribution is first initialized (reference numeral 4210), so that it is empty.

Subsequently, all the segments 52, 54, 56, 58 of path 12, 14 are processed, for each information element 62, 72, 74, 82, 84, 86, 92 in the utilization distribution list the properties of the current segment being accumulated and the starting and ending entries describing the contiguous segment being updated. That is, the current segment is set equal (reference numeral 4220) to the last segment of the path.

It is also checked (reference numeral 4230) whether there is a current segment.

If no segment is present (reference symbol “−”), the sorting (reference numeral 4232) of the utilization distribution list takes place according to the value of the information elements, for instance, decreasing.

If, however, no segment is present (reference symbol “+”), the current information element of the current segment is set equal to the first information element (reference numeral 4240).

It is then checked (reference numeral 4250) whether a current information element is present.

In this context, before taking into consideration the values of the current segment, a new entry is made if the information element does not yet have an entry in the list or if the current segment does not border on the entered segments.

If no current information element is present (reference symbol “−”), the current segment is set equal to the previous segment of path 12, 14 (reference numeral 4252).

On the other hand, if a current information element is present (reference symbol “+”), the current information element is entered in the utilization distribution list, and a segment is determined or newly applied (reference numeral 4260), if not present yet.

Thereupon, the properties of the current segment are updated for the list element (reference numeral 4270).

After the analysis of all the segments of the path, the utilization distribution list is sorted in descending order corresponding to the value of the entries, so that the utilization distribution list may be used as sorting sequence.

The actual sorting 720 of the data of a segment 52 or 54 or 56 or 58 according to a specified sorting sequence is shown in FIG. 11.

The result list is initialized or deleted (reference numeral 7210) before the sorting of the data of a segment.

The current information element is thereupon set equal to the first information element of the specified sorting sequence.

It is then checked (reference numeral 7220) whether a current information element is present. If no current information element is found (reference symbol “−”), the remaining information elements of the information list of the corresponding segment are transferred to the result list (reference numeral 7250).

The result list is then transferred to become the information list of the corresponding segment (reference numeral 7260).

If, however, a current information element is found (reference symbol “+”), a search is made in a subsequent loop, via the information elements of the specified sorting sequence, for the current information element of the entry valid for this segment in the information list of the corresponding segment (reference numeral 7222).

If the current information element of the entry valid for this segment is contained therein (reference symbol “+”), the current information element is transferred into the result list as primary information element (reference numeral 7230) and removed from information list 60 or 70 or 80 or 90 of segment 52 or 54 or 56 or 58 (reference numeral 7240).

In this case, the loop via the information elements of the specified sorting sequence is interrupted and the remaining elements of the current segment are transferred (reference numeral 7250). Subsequently, the result list is allocated to the current segment (reference numeral 7260).

However, if no current information element is present in the information list 60 or 70 or 80 or 90 of the corresponding segment 52 or 54 or 56 or 58 (reference symbol “−”), the current information element is set equal to the next information element of the specified sorting sequence (reference numeral 7224).

In accordance with the example of first route 12, in which the entire route runs on federal road B65 and only touches on federal road B6 and B3 in a shared manner, the following utilization distribution of the road number by length comes about as a result, after sorting:

| | | | | | | | |
|---|---|---|---|---|---|---|---|
| | Route | 12 | B65 | | B6 | | B3 |
| Route List | | 10 | | 10 | | 7 | 6 |
| +B65 | | 2 | | 2 | | | |
| --> E1 | | | | | | | |
| +B6/B65 | | 1 | | 1 | | 1 | |
| --> E2 | | | | | | | |
| +B3/B6/B65 | 6 | 6 | | 6 | | 6 | |
| --> E3 | | | | | | | |
| +B65 | | 1 | | 1 | | | |

Based on this distribution, after sorting according to the exemplary embodiment of the method according to the present invention, shown in FIGS. 9 through 11, one obtains the route list shown below and travel recommendations having an optimized road number sequence.

Since first route 12 completely utilizes federal road B65, there turns out to be no difference for this example from the other two exemplary embodiments of the method according to the present invention (cf. FIGS. 6 through 8).

| Route List | | Travel Recommendations |
|---|---|---|
| +B65 | --> E1 | “turn right and keep following B65” |
| +B65/B6 | --> E2 | “turn left and keep following B65” |
| +B65/B3/B6 | --> E3 | “straight ahead and continue following B65” |
| +B65 | | |

For second route 14 (cf. FIG. 4), one obtains the following utilization distribution of the road numbers by the length of the roads:

| | | | | | | | |
|---|---|---|---|---|---|---|---|
| | Route | 14 | B65 | | B6 | | B3 |
| Route List | | 13 | | 9 | | 7 | 10 |
| +B65 | | 2 | | 2 | | | |
| --> E1 | | | | | | | |
| +B6/B65 | | 1 | | 1 | | 1 | |
| --> E2 | | | | | | | |
| +B3/B6/B65 | 6 | | 6 | | 6 | | 6 |
| --> E3 | | | | | | | |
| +B3 | | 4 | | | | | 4 |

Based on this distribution, the sorting according to the third exemplary embodiment of the method according to the present invention, shown in FIGS. 9 through 11, generates the route list shown below and travel recommendations having an optimized road number sequence for second route 14 (cf. FIG. 4).

Because of federal road B3's greater proportion of the path, the same optimized road number sequence comes about as in the second exemplary embodiment of the present invention.

| Route List | | Travel Recommendations |
|---|---|---|
| +B65 | --> E1 | “turn right and keep following B65” |
| +B65/B6 | --> E2 | “turn left and follow B3” |
| +B3/B6/B65 | --> E3 | “straight ahead and continue following B3” |
| +B3 | | |

In the case of the same route having start and destination exchanged, the place of change of the primary road number remains the same in each case, in contrast to the first and the second exemplary embodiment of the method according to the present invention (cf. FIGS. 6 through 8), for this second route 14 (cf. FIG. 4).

Consequently, the method of the present invention may be used for the optimized mapping of road numbers and road numbers along a route 12, 14.

One advantageous specific embodiment of the present invention is reflected in
the optimized display of road names and/or road numbers, particularly in the so-called road name list or route information list, and/or
the optimized acoustical presentation of road names and/or road numbers in travel recommendations.

1-12. (canceled)

13. An information processing system for processing data with regard to successive units, comprising:
at least one information list having at least one information element allocated to each unit;
wherein in at least one of the information lists, at least one of the information elements weightable while taking into consideration at least one of (a) a relationship and (b) a relationship as a function of an order, of the unit to which this information list is allocated, to at least one of further unit.

14. The system according to claim 13, wherein the information processing system is arranged as a navigation assistance device.

15. The system according to claim 13, wherein the system is adapted to process data with regard to successive at least one of (a) spatial and (b) temporal segments.

16. The system according to claim 13, wherein the system is adapted to process data regard to route segments of at least one path.

17. The system according to claim 13, wherein at least one of:
(a) the at least one information element is allocatable during the weighting to at least one of at least two priority categories; and
(b) the at least one information element in the respective information list is sortable with respect to at least one of (a) a weighting, (b) an order and (c) a sequence of the information elements in the respective information list reflecting at least one of (a) an importance and (b) a significance of the respective information element.

18. The system according to claim 17, wherein the priority categories include at least one of (a) a primary information element and (b) an alternative information element.

19. The system according to claim 13, wherein at least one of:
(a) at least one of (i) the information lists each refer to at least one of (a) an information category and (b) an information type and (ii) the at least one information element of the respective information list has at least one of (a) a road name and (b) a road number;
(b) in the weighting of the at least one information element of the respective information list only the information lists, relating to at least one of (a) a same information category and (b) a same information type, of the other units are to be taken into consideration; and
(c) the weighting of the respective information elements of information lists of at least one of (a) different information categories and (b) different information types is determinable in a different manner.

20. The system according to claim 13, wherein the weighting of the respective information element is determinable at least one of:
(a) by the weighting of corresponding information element in at least one of: (a) the further units, (b) in a preceding spatial segment, (c) a succeeding spatial segment, (d) a preceding temporal segment, and (e) in a succeeding spatial segment; and
(b) by a probability that at least two of the information elements that are allocated to the respective units are at least one of (a) in connection with each other and (b) contiguous.

21. A navigation system a locomotion device, comprising:
a device adapted to determine possible routes from a starting point to a destination with the aid of at least one of (a) route network data and (b) road network data;
a device adapted to specify a preferred route;
a device adapted to output travel recommendations which lead at least one user along the specified route;
at least one information processing system adapted to output as at least one of the travel recommendations at least part of weighted data allocated to a category primary information element.

22. The system according to claim 21, wherein the information processing system is adapted to process data with regard to successive units, the information processing system including at least one information list having at least one information element allocated to each unit; and
wherein in at least one of the information lists, at least one of the information elements weightable while taking into consideration at least one of (a) a relationship and (b) a relationship as a function of an order, of the unit to which this information list is allocated, to at least one of further unit.

23. A method for processing data with regard to successive units, comprising:
allocating at least one information list having at least one information element to each unit;
weighting in at least one of the information lists at least one of the information elements while taking into consideration at least one of (a) a relationship and (b) a relationship as a function of order of the unit, to which the information list is allocated, to at least one further unit.

24. The method according to claim 23, wherein the data includes data with regard to at least one of (i) successive at least one of (a) spatial and (b) temporal segments and (ii) route segments of at least one path.

25. The method according to claim 23, wherein at least one of:
(a) the at least one information element is allocated during the weighting to at least one of (a) at least two priority categories, (b) a primary information element category, and (c) an alternative information element category; and
(b) the at least one information element in the respective information list is sorted with respect to at least one of (a) the weighting, (b) an order, and (c) a sequence of the information elements in the respective information list reflecting at least one of (a) an importance and (b) a significance of the respective information element.

26. The method according to claim 23, wherein at least one of:
(a) the information lists each refer to at least one of (a) an information category, (b) an information type, (c) a road name, and (d) a road number;
(b) in the weighting of the at least one information element of the respective information list only the information lists, relating to at least one of (a) a same information category and (b) a same information type, of the other units are taken into consideration; and
(c) the weighting of the respective information elements of information lists of at least one of (a) different information categories and (b) different information types is determined in a different manner.

27. The method according to claim 23, wherein the weighting of the respective information element is determined at least one of:
(a) by the weighting of the corresponding information element in at least one of (a) at least one of the further units, (b) in a preceding spatial segment, (c) a succeeding spatial segment, (d) a preceding spatial segment, and (e) a succeeding temporal segment in at least one of (a) a preceding and (b) succeeding route segment of a path; and
(b) by a probability that at least two of the information elements that are allocated to the respective units are at least one of (a) in connection with each other and (b) contiguous.
